(19) United States
(12) Patent Application Publication
(10) Pub. No.: US 2014/0046701 A1
(43) Pub. Date: Feb. 13, 2014

(54) Apparatus and Method for Detecting Driving Performance Data

(71) Applicant: Insurance Services Office, Inc., Jersey City, NJ (US)

(72) Inventors: Oren Steinberg, Tel-Aviv (IL); Asaf Tamir, Tel-Aviv (IL); Avner Freiberger, Kfar-Saba (IL); David Izhaky, Tel-Aviv (IL); Amichai Painsky, Ra'anana (IL); David Aviv, Tel-Aviv (IL); Peleg Bachar, Rishon Le'Ziyon (IL)

(73) Assignee: Insurance Services Office, Inc., Jersey City, NJ (US)

(21) Appl. No.: 13/964,568

(22) Filed: Aug. 12, 2013

Related U.S. Application Data
(60) Provisional application No. 61/682,263, filed on Aug. 12, 2012.

(51) Int. Cl. G06Q 40/08

(52) U.S. Cl. CPC G06Q 40/08
USPC 705/4

(57) ABSTRACT

A system and method for detecting driving performance data is provided. The system and method include a mobile device in electronic communication with a network and one or more sensors for measuring at least one parameter associated with operation of a vehicle. A driving performance engine in electronic communication with the mobile device. The driving performance engine verifies the vehicle and a driver of the vehicle, detects vehicle movement by comparing sensor data obtained by the mobile device with a predefined set of rules, records driving performance data, transmits the driving performance data anonymously to an insurance provider computer system, and receives insurance cost information from the insurance provider computer system based on the driving performance data.

### CROSS-REFERENCE TO RELATED APPLICATIONS

This application claims the benefit of U.S. Provisional Application Ser. No. 61/682,263 filed on Aug. 12, 2012, the entire disclosure of which is expressly incorporated herein by reference.

### BACKGROUND OF THE INVENTION

1. Field of the Invention

The present invention relates generally to gathering information related to driving performance data, such as driving styles, behaviors, and performance of drivers, as well as other information.

2. Discussion of the Related Art

With the proliferation of mobile devices and wireless communications in and around vehicles, it has become more economical to collect data from such devices for a large variety of reasons/purposes, including for auto insurance-related purposes. Devices used today to collect driving data are mostly after-market monitoring devices that are installed by a technician, owner of the vehicle, or other individuals. Other devices are part of the vehicle, although they are still less accessible to third parties, such as insurers.

As personal mobile phones, smartphones, etc., are becoming increasingly ubiquitous, insurers are starting to see the benefits of communicating through them directly with policyholders. Many insurers offer mobile phone applications that communicate insurance information to consumers. Very few use mobile phones for collecting data from consumers, such as to monitor their driving.

There is a need to use mobile phones for device-based insurance programs. While doing so is a logical step forward, certain obstacles make such use difficult, specifically with respect to preserving the quality and integrity of such data.

Insurance companies have started to use data monitoring devices installed in vehicles (e.g., telematics devices) to examine how people drive. In recent years, such companies have been offering Usage-Based Insurance (UBI) programs to consumers, where the price of the insurance policy is linked to data supplied from a dedicated device installed in the vehicle. Most programs use mileage or duration of trips to discount insurance rates for low-mileage drivers. Fewer programs use speed and acceleration measurements to discount safe drivers by tracking risky driving events (speeding, braking, etc.). UBI is considered an important step in making insurance more affordable, fair, and transparent to consumers.

### SUMMARY

The present disclosure provides a system and method for detecting driving performance data. The system and method include a mobile device in electronic communication with a network and one or more sensors for measuring at least one parameter associated with operation of a vehicle. A driving performance engine in electronic communication with the mobile device. The driving performance engine verifies the vehicle and a driver of the vehicle, detects vehicle movement by comparing sensor data obtained by the mobile device with a predefined set or rules, records driving performance data, transmits the driving performance data anonymously to an insurance provider computer system, and receives insurance cost information from the insurance provider computer system based on the driving performance data.

### BRIEF DESCRIPTION OF THE DRAWINGS

The disclosed subject matter will be described with reference to the following description in conjunction with the figures. The figures are generally not shown to scale and any sizes or actual positions are not necessarily limiting.

FIG. 1 is a diagram showing an apparatus and method for detecting driving performance data;

FIG. 2 illustrates a vehicle environment wherein a driver's performance can be monitored according to the present disclosure;

FIG. 3 is a flowchart showing processing steps for automatically collecting driving performance data;

FIG. 4 is a flowchart showing additional processing steps for automatically collecting driver performance data;

FIG. 5 is a flowchart showing processing steps for automatically classifying driving styles and associating drivers with such styles;

FIG. 6 is a flowchart showing processing steps for obtaining insurance offers based on monitored driver performance data;

FIG. 7 is a flowchart showing processing steps for automatically detecting and reporting a vehicle accident;

FIG. 8 is a flowchart showing processing steps for searching a database for accident information;

FIG. 9 is a flowchart showing processing steps for providing feedback to a driver according to detected driving performance data;

FIG. 10 is a flowchart showing processing steps for supplementing sensor data;

FIG. 11 is a flowchart showing overall processing steps carried out by the system for handling driving performance data; and

FIG. 12 is a diagram showing hardware and software components of the system.

### DETAILED DESCRIPTION

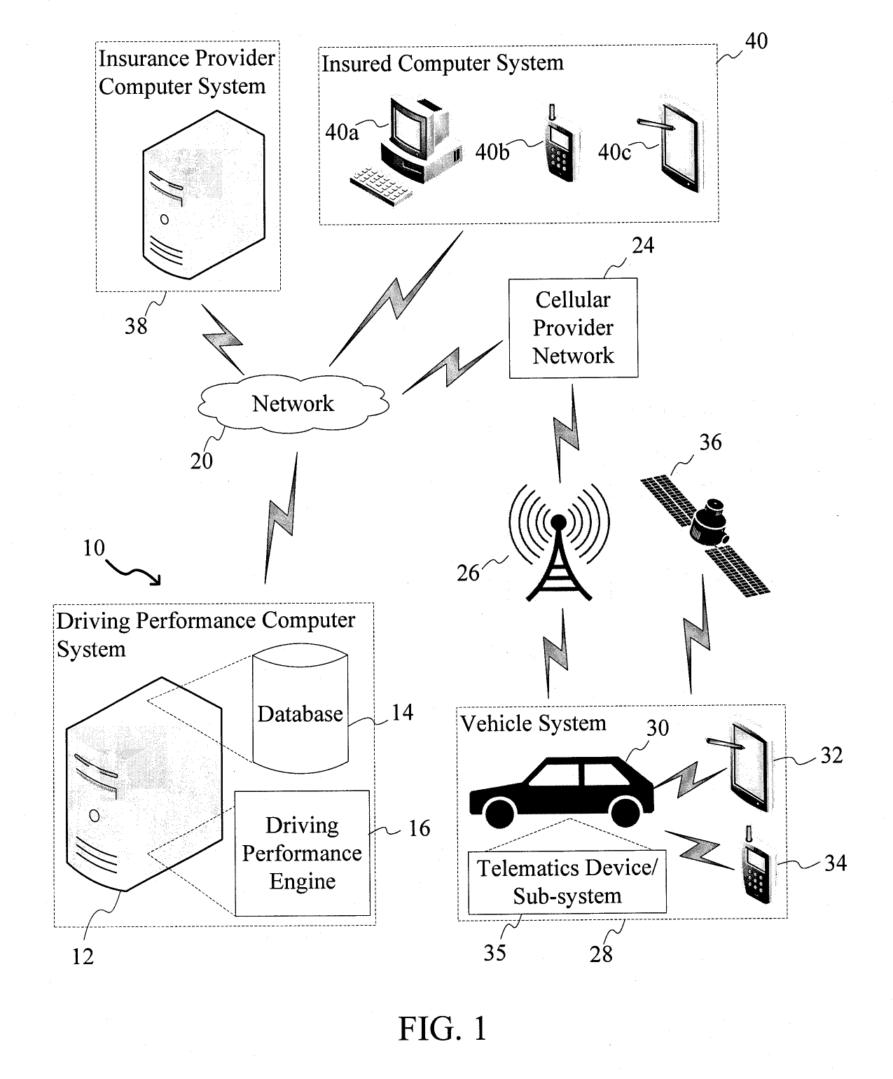

FIG. 1 is a diagram showing an apparatus and method for detecting driving performance data. The system, indicated generally at 10, comprises a computer system 12 (e.g., a server) having a database 14 stored therein and a driving performance engine 16 executed by the computer system 12. The computer system 12 could be any suitable computer server (e.g., a server with a microprocessor, multiple processors, multiple processing cores) running any suitable operating system (e.g., Windows by Microsoft, Linux, etc.). The database 14 could be stored on the computer system 12, or located externally (e.g., in a separate database server in communication with the system 10). As will be discussed in greater detail below, the engine 16, when executed by the computer system 12, provides the functionality described herein.

The system 10 communicates through a network 20 with one or more of a variety of computer systems. Network communication could be over the Internet using standard TCP/IP or UDP communications protocols (e.g., hypertext transfer protocol (HTTP), secure HTTP (HTTPS), file transfer protocol (FTP), electronic data interchange (EDI), dedicated protocol, etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format.

More specifically, the system 10 communicates with one or more vehicle systems 28 through a network 20, a cellular provider network 24, and one or more cellular antenna towers 26. The vehicle system 28 includes a vehicle 30 and one or more portable mobile devices (e.g., portable tablet computer 32, portable smartphone 34, telematics device 35, and/or telematics sub-system 35 of the vehicle). Portable mobile device means that that the device is configured to be easily taken into and out of a vehicle (e.g., not a permanent fixture in the vehicle). Additionally, an onboard diagnostics (OBD) system of the vehicle 30 and/or a telematics device 35 could communicate with the one or more mobile devices 32, 34, 35 as a complement or supplement to the mobile device or as the main source for data collection (e.g., to identify the vehicle using vehicle identification number (VIN) validated through the OBD port). The vehicle 30 itself and/or the mobile devices 32, 34, 35 could also communicate with a satellite system 36, such as for obtaining global positioning system (GPS) information. Information from the vehicle system 28 is transmitted periodically or continuously to the driving performance computer system 10 and/or stored in the database 14. However, at least some, if not all, of the functionality of the system 10 could be performed locally on mobile devices 32, 34, 35 (e.g., personal computer, smart cellular telephone (Apple iPhone), tablet computer, etc.) programmed with software (e.g., a software application or “app”) in accordance with the present disclosure.

Further, the driving performance computer system 10 could electronically communicate with one or more insurance provider computer systems 38 and one or more insured computer systems 40 (e.g., personal computer system 40a, a smart cellular telephone 40b, a tablet computer 40c, or other devices). Additionally, or alternative, an aggregator (e.g., online referrals agent), an insurance broker, etc. could also use and be in communication with the system.

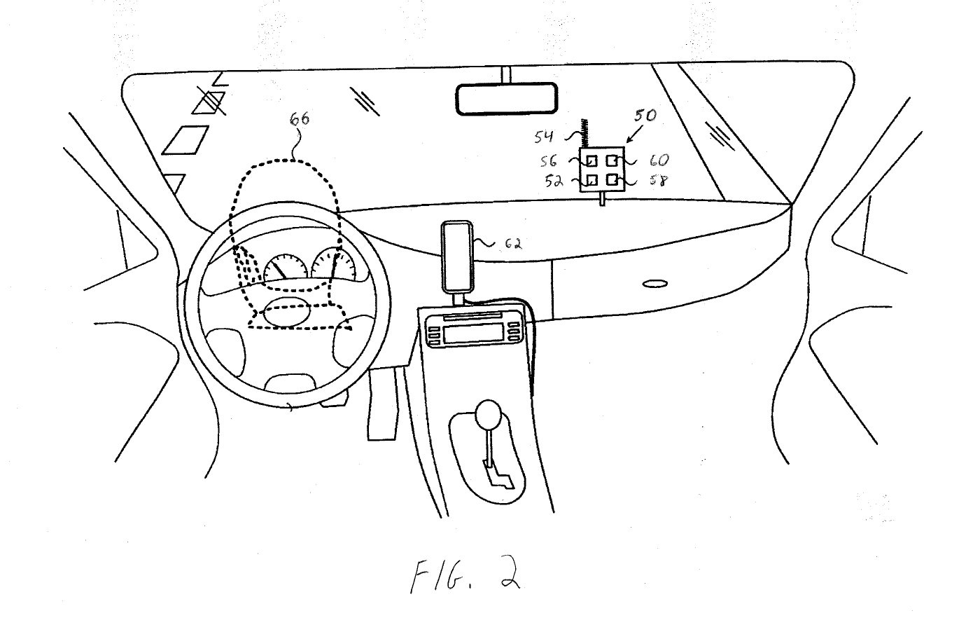

FIG. 2 illustrates a vehicle environment wherein a driver's performance can be monitored according to the present disclosure. Much of the data gathered in monitoring the driver's 66 performance is detected from the driver's mobile device 50 (which corresponds to the devices 32 and/or 34 shown in FIG. 1 and discussed above). As mentioned above, the mobile device 50 could be a cellular phone, a PDA, a laptop, a tablet computer, a navigation system, a dedicated monitoring device, a plug linked to the car computer, etc. The mobile devices could be placed inside the vehicle, mounted on a docking station, attached to the windshield, or attached to any sub-system in the vehicle. The mobile device 50 comprises a gyroscope device 52 used to measure the movement of the mobile device 50 in various axes. The mobile device 50 further comprises an accelerometer 58 for measuring forces applied on the mobile device 50 in various axes. Further, the orientation could be measured using a compass device.

The mobile device 50 further comprises a driver's performance memory/storage 60, for storing driving performance data related to the driver 66. Such driving performance data could be the force measured by the accelerometer at a specific point in time. The driver's performance storage 60 could also associate time, location, and additional driving information as part of the driver's performance. Such additional driving information, as well as the force and location, could be transmitted to a driving performance server (e.g., the server 12 of FIG. 1) for further processing. Such transmission could be performed using a cellular transceiver at the mobile device 50 or using another transmitter connected to the driver's performance storage 60. The mobile device 50 could further comprise a GPS receiver 54, or another device capable of receiving an indication as to the geographic coordinates of the mobile device 50. The GPS receiver 54 could communicate directly with the driver's performance storage 60, such that the driver's performance storage 60 stores the location of the mobile device 50, as well as different time stamps. The location of the mobile device 50 could be transmitted to a driver's performance processor 56 that determines the velocity and direction of the mobile device at different times and at different locations.

As the driver's performance storage 60 and the driver's performance processor 56 are located at the mobile device 50 or communicate with the mobile device 50, the driver's performance processor 56 detects the driver's use of the mobile device 50 while driving. Such use of the mobile device 50 could include phone calls (inbound or outbound), text messaging, applications usage, holding the mobile device, and general device activation. Data related to the use of the mobile device 50 while driving could originate from software residing on the mobile device 50 itself or in the cellular company's premises (e.g., see cellular provider network 24 of FIG. 1). Data related to the use of the mobile device 50 while driving could also originate from a dedicated device or the car's sub-systems, if they are linked to the mobile device 50, for example through Bluetooth (or any suitable Near Field Communication protocol). Data related to the use of the mobile device 50 while driving could also be obtained by a proximity sensor in the phone that measures proximity of a person to the user's device.

The driver's performance storage 60 could associate time and location to the data related to the use of the mobile device 50 while driving. Additional information that could be associated with use of the mobile device 50 includes the speed of the vehicle during use of the mobile device, the forces measured by the accelerometer 52, the dynamics measured by a gyroscope, etc.

The driver's performance storage 60 and the driver's performance processor 56 obtain verification data that verifies that the driving performance detected by the mobile device 50 relates to the correct vehicle. Verifying the association of the driving performance data could be performed by the driver inputting the vehicle identification into the mobile device 50.

Verification of the vehicle associated with the mobile device could be achieved by linking the mobile device 50 with sub-systems of the vehicle using wired or wireless connections. In some vehicles, and in many Bluetooth systems, it is possible to uniquely identify the vehicle through the Bluetooth connection. However, this solution may not be applicable to all vehicles. In some cases where Bluetooth connection is unavailable, the mobile device 50 could be linked directly to the vehicle computer using an OBD port 62 that provides access to the vehicle's computer. The connection is achieved using a dedicated cable, or preferably using a verification dedicated device that connects to the OBD port 62. The verification dedicated device serves as a gateway between the OBD port 62 and the mobile device 50 (e.g., via a Bluetooth connection with the mobile device 50). The verification dedicated device could transmit OBD port 62 readings through a wireless link (e.g., Bluetooth) or it could only receive power through the OBD and communicate with the phone which would use its own sensors to collect the data. Using the verification dedicated device, the mobile device 50 can read the vehicle identification number (VIN) through the OBD port 62 and initiate wireless connection every time it is near or inside the vehicle. Another method is to allow a user to register a trip as not occurring in his or her own vehicle, whether before, during, or after the trip.

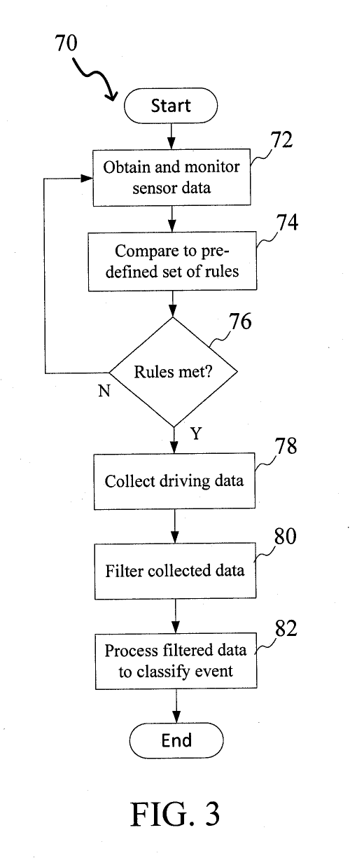

FIG. 3 is a flowchart showing processing steps 70 for automatically collecting driving performance data. In step 72, the system obtains and monitors sensor data, such as velocity, acceleration, etc. Such data could be provided by sensors with the mobile device installed in a vehicle. In step 74, the system compares the sensor data to a predefined set of rules (e.g., threshold), and/or to compare different data characteristics. For example, to detect driving events (e.g., turning events, negotiating a curve, turning in an intersection, merging onto a highway) the system uses predefined rules, such as rules that incorporate an angle of a turn or curve, elevation of a road (e.g., incline of the road), type of road segment (e.g., curve, turn, ramp, merge, etc.), velocity (e.g., before, during, and after the turn), accelerations in three dimensions (e.g., before, during, and after the turn), use of brakes (e.g., before and during the turn), acceleration (e.g., out of the turn), etc.

In step 76, a determination is made as to whether one or more of the set of rules are met (e.g., threshold exceeded) and/or whether predefined data characteristics are identified. If a negative determination is made, the process returns to step 72. Otherwise, in step 78, the system collects driving data (e.g., begins collecting driving data, expands or increases the types of data being collected, etc.). Additionally, the system could use the data collected from the sensors and complement it with data from a geographic information system (GIS) database (e.g., road segment characteristic, weather, etc.). Importantly, the system detects when a vehicle is moving and only then triggers the collection of the data, so as to guard against false triggering of data collection (e.g., if the mobile device is suddenly dropped or otherwise moved outside of a vehicle). As mentioned above, vehicle movement could be determined by the system by monitoring the velocity of the vehicle, accelerations, change of cellular tower, or other sensor changes.

In step 80, the system filters the collected data to detect and remove noise (e.g., caused by road humps), such as by using 3 dimensional accelerations. As an example, the system could look at a simple threshold and/or examine the distribution of data along a turn process (e.g., peaks and lows), such as for velocity, side accelerations, and/or frontal accelerations (e.g., braking and acceleration). Then the system could employ any one or more known techniques for cleaning the data and removing “noise.” In step 82, the system processes the filtered data to classify one or more events. For example, to determine whether an event actually occurred and the degree of its severity or risk, the system could use any one or more known methods based on expert knowledge, statistical modeling, data comparison with other vehicles that drove the same or similar road segments, etc.

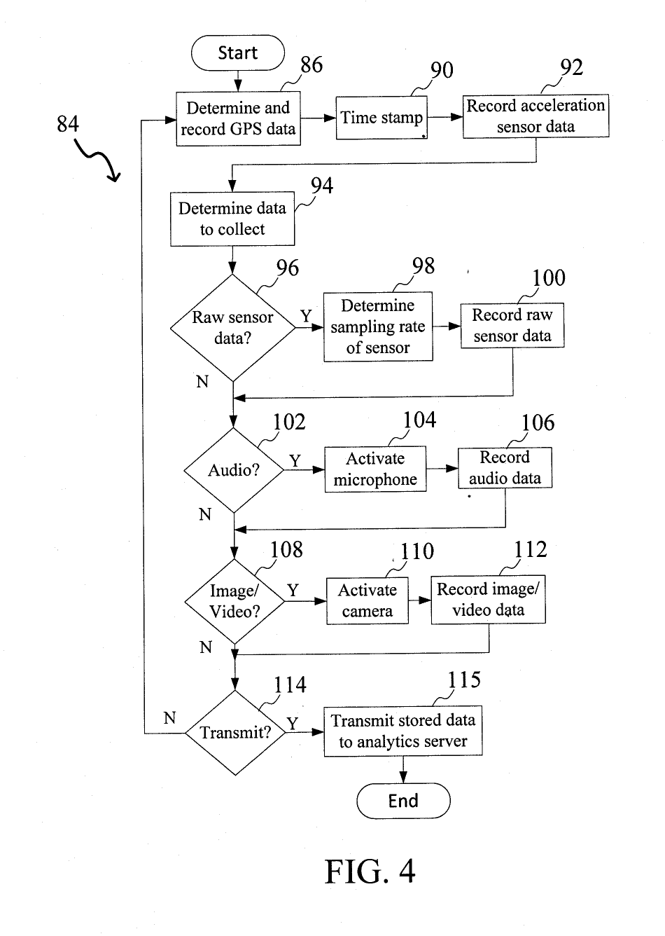

FIG. 4 is a flowchart showing additional processing steps 84 for automatically collecting driver performance data. The system could provide media files as part of the driver's performance data. Such media files could include audio, image and video files taken using a camera or a microphone located at the mobile device. The data of the media file could be analyzed in the vehicle or in the server and could be used to trigger, detect or evaluate, or demonstrate the driver's performance at a specific time. The media files could be deleted according to storage requirements or in conjunction with other driving performance data. Also, the media files could be time-stamped and associated with a particular driving event (e.g., extreme brakes), and stored in the database. The media files and related information could then be subsequently analyzed along with the driving event.

In step 86, the system determines and records GPS data. In step 90, the data being collected by the system is time stamped (e.g., date and time). In step 92, acceleration sensor data is recorded. In step 94, the system determines specific data to collect. This determination could be made based on the severity of recorded events. For example, if a gradual increase in speed is detected, the system may only record speed data, but if a very sudden and severe acceleration is detected, the system could record both raw sensor data (including speed and acceleration), as well as audio, images, and/or video. In step 96, the system determines whether to collect raw sensor data. If not, the process proceeds to step 102. Otherwise, in step 98, the system determines the sampling rate (e.g., high sampling rate) of the sensor and in step 100 records the raw sensor data (e.g., through the OBD port or using Bluetooth), and then proceeds to step 102. In step 102, the system determines whether to collect audio data. If not, the process proceeds to step 108. Otherwise, in step 104, the system activates the microphone, and in step 106, audio data is recorded, and then proceeds to step 108. In step 108, the system determines whether to collect image or video data. If not, the process proceeds to step 114. Otherwise, in step 110 the system activates the camera, and in step 112 begins recording image and/or video data, and then proceeds to step 114. In step 114, the system determines whether to transmit the data. If not, the process reverts back to step 86. Otherwise, in step 115, the system transmits the stored data to an analytics server (where the data could optionally be compressed before transmission). Any suitable protocol could be used for transmission (e.g., WiFi), such as for transmitting large amounts of data (e.g., video data). Additionally, the system could examine and parse the recorded data and omit or delete unnecessary data (e.g., before transmitting the data to the database). Also, the system could keep data above a “white noise” threshold (e.g., for acceleration sensor data), and optimize the data (e.g., before transmitting the data to the database).

The system could verify if and how much the vehicle was driven without using the mobile device 50 (see FIG. 2) for detecting driver's performance data. For example, the system could verify that the mobile device 50 was not left at home or turned off while the vehicle was driven. Verification of the mobile device 50 connection during driving could be accomplished by comparing the mileage measured by the GPS receiver and the driver's performance storage 60 to the mileage determined by the vehicle computer or reported by the driver. Another alternative for identifying missing driving data (e.g., vehicle was driven without the phone) is based on analysis of the driving and trips (e.g., if a trip starts far away from where the previous one ended).

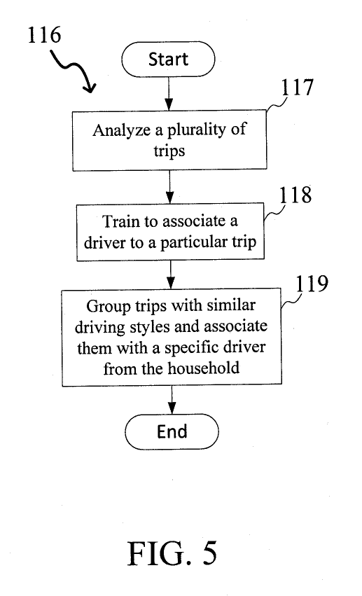

FIG. 5 is a flowchart showing processing steps 116 for automatically classifying driving styles and associating drivers with such styles. The system could also automatically identify a driver, such as when a plurality of drivers use the same vehicle (e.g., three drivers of the same family use the same vehicle and it is difficult to distinguish between the different drivers). Distinguishing between drivers is especially important when providing feedback to the drivers of the household and identifying a “troublemaker” driver or when insurance coverage is linked to a specific driver (e.g., a young driver). It is also useful in building all sorts of games and social applications that compare drivers to their peer groups, etc. For this purpose, the system provides the ability to distinguish between different driving styles of the same vehicle.

In step 117, the system analyzes a plurality of vehicle trips. In step 118, the user “trains” the system to associate a driver to one or more particular trip. In step 119, trips with similar driving styles are grouped and associated with a specific driver from the household. Each trip is analyzed separately to determine the specific driving style that was used, as each trip is assumed to be a single driver. In a matter of a few trips, the system is able to associate the drivers by itself. For example, the system could present the driver or the vehicle owner with all of the trips of the last week, either grouped by driving styles or in plain chronological order, and asks the user to point out which driver was driving the vehicle in each of those trips. The system then uses those inputs to associate each driving style with the name or other identifier of a driver, and is then able to determine which driver drove the vehicle in every new trip. This is valuable for providing personalized and effective driving feedback to drivers, or if insurers want to price young drivers separately from the other drivers in the household, or if insuring a commercial vehicle.

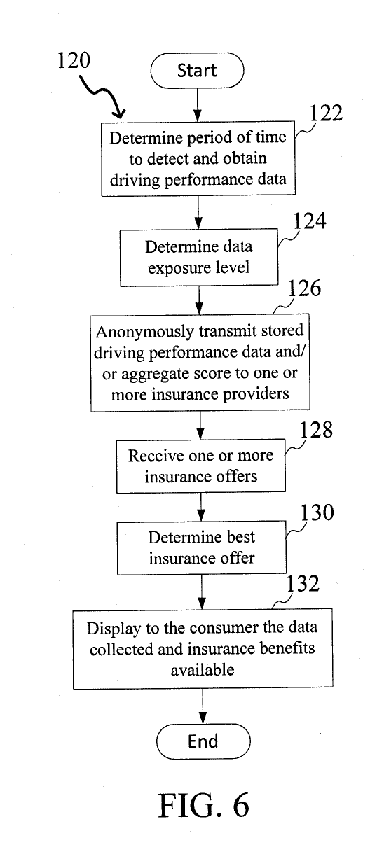

FIG. 6 is a flowchart showing processing steps 120 for obtaining insurance offers based on monitored driver performance data. The system could use the driver's performance data stored at the mobile device associated with the driver or vehicle (or at a remote driving analysis and storage server 12 of FIG. 1). As such, the data is not controlled by any insurer. As the driver's performance data is stored at the mobile device, a driver's performance application operating at the mobile device, or at a remote driver performance server, could communicate with a plurality of insurers. The system of the present disclosure transmits driving performance data or other data products to insurers in order to receive insurance offers. The driving performance data could be anonymous, such that the only factor is the driver's actual performance.

In step 122, the system determines a period of time in which to detect and obtain driving performance data. The system could also detect data for a limited period of time and use that data to receive insurance benefits (rate, discount, etc.). For example, the system could collect data for a period of two weeks, one month, three months, or up to an amount of one thousand miles, thirty hours of driving, etc. The amount of data could vary by driving style, by actual exposure to risky events, by relativity to other drivers, by seasonality, etc. Generally, the more data collected, the better the predictive power of that sample would be and a better rate or discount could be granted.

In step 124, the system determines a data exposure level. The driver or the application determines a data exposure level provided to insurers for maintaining privacy, such as providing only raw data. Raw data could include the number (and other statistical parameters) of extreme brakes or any other type of driving event. Another example of raw data is an aggregated score or grade provided by the driver's performance application for a period of time, either predefined (such as trip, day, week, month, year) or optimized by the performance application. The driver could, for example, determine to expose only the age but not the residence, claims record, gender, etc. The driver could choose to expose only his or her previous year data, or the current year, or any part of the monitoring period.

In step 126, the system anonymously transmits stored driving performance data and/or aggregate score to one or more insurance providers. The driver's performance data could be transmitted along with general data (as disclosed above) or as gathered by the mobile application (e.g., where the vehicle parks every night, other habits and social information, etc) in anonymous or partially-anonymous format, in accordance with how the driver configures the driver's performance application. The driver's performance data is transmitted to a plurality of insurers. The data transmission could be performed via a server communicating with the driver's performance application.

In step 128, the system receives one or more insurance offers from one or more insurance providers. In step 130, the system determines the best insurance offer. The driver or the performance application could determine the best offer anonymously. In step 132, the system displays to the consumer the data collected and insurance benefits available. The system optimizes the amount of the data samples collected according to the insurance benefits that can be obtained. The system presents to the consumer data that has been collected and insurance benefits he or she can receive from existing insurers already, as well as additional insurance benefits from different insurers that could be received if the driver continues to collect data for an extended period of time.

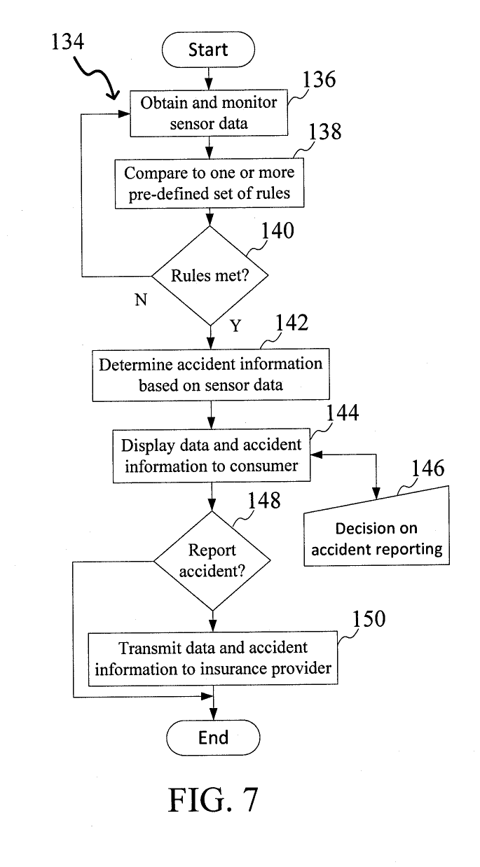

FIG. 7 is a flowchart showing processing steps 134 for automatically detecting and reporting a vehicle accident. The system could also detect data that could be used to analyze an insurance claim. For example, the monitored driving performance could be used to analyze an accident (e.g., whether the driver used the mobile phone prior to the accident, the forces measured by the accelerometer, etc.). The data related to accidents could be made available by the driver or be requested by insurers based on claims filed that are reported by the driver or third party claimants. In some cases, the system could detect an accident according to predefined rules, accidents that are not reported nor claimed, etc.

In step 136, the system obtains and monitors sensor data (e.g., velocity, acceleration, deceleration, location, etc.). In step 138, the system compares the sensor data to one or more predefined set of rules. In step 140, the system determines whether one or more of the set of rules has been met. If not, the process reverts back to step 134. Otherwise, the process proceeds to step 142, and the system determines accident information based on the sensor data. The system associates several basic details related to the accident. Such basic details could be the velocity of the vehicle (before, during, and after the impact), location of the accident, type of road segments on which the accident occurred, force of impact in different axes, dynamics and movement of the vehicle (before, during, and after the impact), environmental attributes (weather, lighting, congestion as could be correlated with data from third party service providers), etc. Once those elements are evaluated, additional information could be derived, such as the type of the accident (frontal, side, etc.), severity of impact, expected damage type, expected damage cost, contribution of each party to the accident and the respective liability, etc.

In step 144, the accident data and accident information determined by the system is displayed to the driver or vehicle owner. In step 146, the driver or the vehicle owner inputs any revisions in the report generated by the system, and decides whether to report the accident. In step 148, the system determines whether the driver or the vehicle owner desires to report the accident based on the input. If not, the process ends. Otherwise, in step 150, the system transmits data and accident information to an insurance provider. In this way, the system could present the data to the consumer first, enabling the driver or the vehicle owner to decide whether he or she wants to report the accident and/or the data to the insurer.

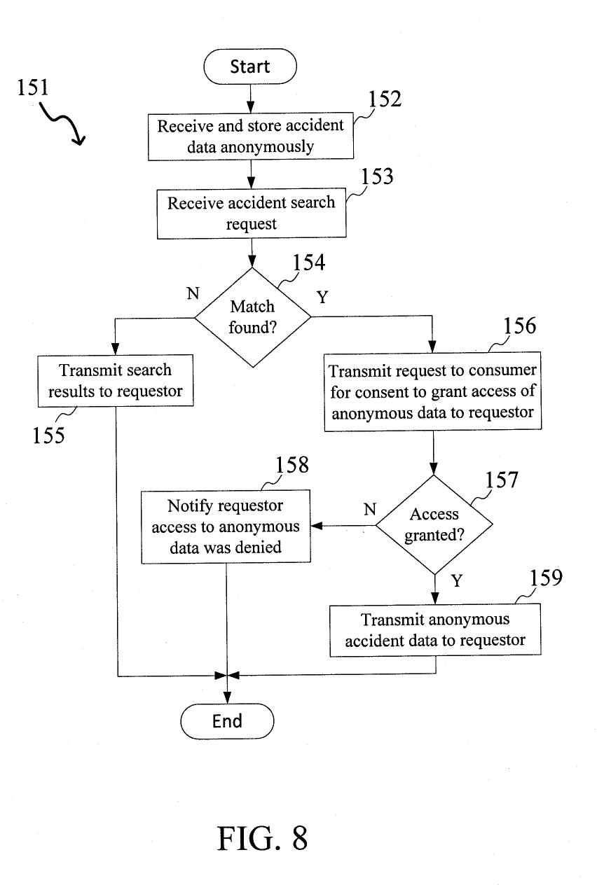

FIG. 8 is a flowchart showing processing steps 151 for searching a database for accident information. In step 152, the system receives and stores accident data anonymously. In step 153, the system receives an accident search request from an insurer or other a requestor (e.g., search criteria could include time, location, car type, etc.). In step 154, the system determines whether there is data that matches the search inquiry of the requestor. If the system determines that there is not any matching data, then in step 155, the system transmits the search results to the requestor to notify that there is no data matching the search request. Otherwise, if the system determines that there is matching data, then in step 156, the system transmits a request to the driver or vehicle owner associated with the matching data. The request seeking consent from the driver or vehicle owner for the system to grant the requestor access of the anonymous data. In step 157, the system determines whether the driver or vehicle owner has granted access to the anonymous data. If access has not been granted, then in step 158, the system notifies the requestor that access to the anonymous matching data was denied. Otherwise, if the system determines that access has been granted, then in step 159, the system transmits the anonymous accident data to the requestor. Alternatively, the data could be sent automatically or anonymously without the driver's or vehicle owner's consent.

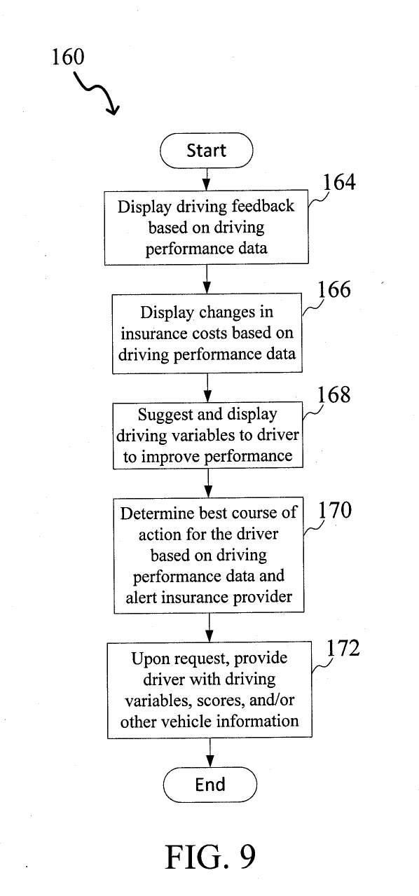

FIG. 9 is a flowchart showing processing steps 160 for providing feedback to a driver or a vehicle owner based on detected driving performance data. In step 164, the system displays driving feedback based on driving performance data. The system that resides on the mobile device of the driver provides feedback to the driver or the vehicle owner according to the detected driving performance data. The feedback could include driving habits, driving events, risk and safety levels determined according to the driving performance data. In step 166, the system displays changes or potential changes in insurance costs based on driving performance data. The feedback could include changes in insurance costs according to specific actions or events performed by the driver (e.g., showing that a specific driving pattern recurring over time results in a 5 percent increase in the insurance costs). This way, drivers or vehicle owners can understand the implications of their driving habits and are incentivized to improve.

In step 168, the system suggests and displays driving variables to the driver to improve driving performance. The driving variables shown to the driver in the feedback are determined according to both prediction of risk and effect of behavioral coaching. Focusing the driving variables on behavioral aspects of the daily routines of drivers enables drivers to easily relate to those behaviors and act on them while on the road.

In order to increase the engagement of the driver with the application, the system could also raise and suggest questions or information displayed to the driver, urging the driver to relate to the driving variables that are more dominant. The relevant driving variables could be displayed on a map, so that the driver can reconstruct the event. In some cases, the variables are displayed as an image or a video clip. The features could be accessed by the driver or the vehicle owner over a phone, a handheld device, TV, or computer when the driver so chooses. Also, certain alerts and reports could be periodically provided to the driver (e.g., push method) or at the end of the trip.

In step 170, the system determines the best course of action for the driver based on driving performance data and alerts the driver's insurance provider. The system could use the driving performance data to determine the best course of action to be taken by the driver at a specific driving event or driving behavior. If, for example, a driver has a consistent tailgating tendency, the system could alert an insurance company to offer or force the driver to use a safety system that promotes safe distance keeping (e.g., alert systems such as phone applications, radars, or cameras that detect tailgating and alert the driver). In another example, if the driver repeatedly suffers from awareness problems, the system could alert the insurer to offer or force the driver to use a distracted driving system that limits his use of the phone while driving or alerts him to keep focused at times of fatigue or long journeys.

In step 172, upon request, the system provides the driver with driving variables, scores, and/or other vehicle information. The system could also enable the driver to access driving variables and scores for purposes of displaying safe driving to employers (or potential ones) or to potential buyers of the driver's car, as an indication of the wear-and-tear level of the vehicle.

The system could also provide the driver with information related to fuel consumption of the vehicle, in relation to driving performance. The system incentivizes drivers to drive more economically and environmentally aware. Each driving variable is correlated with fuel consumptions and/or fuel efficiency and the system determines the corresponding fuel score and fuel efficiency score. Web or phone applications could provide the list of driving variables and their applicable fuel and economic implications.

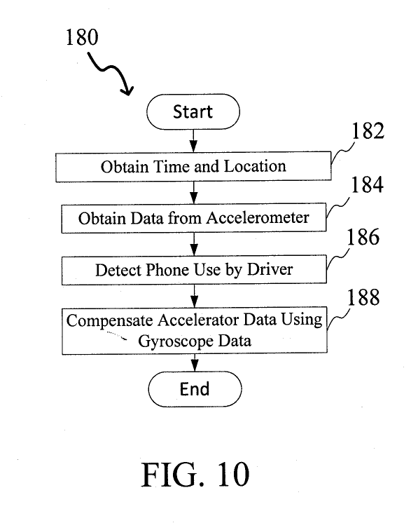

FIG. 10 is a flowchart showing processing steps 180 for supplementing sensor data. In step 182, the system associates a time and location to driver's performance data, such as a driving event, which could be provided using accelerometer measurements. In step 184, the system obtains information from the accelerometer. Accelerometers, in general, measure less effectively when experiencing continuous vibrations or frequent changes in spatial orientation. One method to increase the effectiveness of accelerometers' measurements is to mount the mobile device carrying the accelerometer on a common docking station (cradle) that is fixed to the windshield or dashboard of the vehicle. Another method for improving the effectiveness of the accelerometer comprises continuously monitoring whether the phone is in the same position and orientation in the vehicle. Once the position or orientation changes, the method detects the change and determines the new position or orientation of the mobile device and analyzes the accelerometer data accordingly. Another method to improve the effectiveness of the accelerometer is according to phone carrying profiles (e.g., strong mounting, loose mounting, handheld, etc.) where different profiles can be distinguished by phone sensors, such as a gyroscope, compass, GPS, etc. For each profile, a different set of detection, calibration, and compensation rules could be applied to improve the effectiveness of the accelerometer measurements.

In step 186, the system detects phone use by the driver. Phone use by the driver could result in moving the mobile device from its position or orientation in the vehicle. The phone use data could be, for example an incoming/outgoing call. Other detections could be on changes of position or orientation. Upon detection of such changes, the system could ignore the driver's performance data at the relevant time segment (e.g., 15 seconds from the incoming call). Alternatively, in step 188, the system could compensate for the changes in position by reading additional sensors from the device that are not affected the same way by such changes. Examples of such other sensors include a gyroscope, a magnetic field sensor, a GPS receiver, etc.

The system processes the received driver's performance data to determine the position and orientation of the mobile device continuously or at different time frames. Such determination could be performed based on readings from different sensors of the mobile device and by measuring the averages and changes per second (or sub-second) timeframe. Once a significant change in driver's performance data is detected (e.g., an abrupt change in position or orientation, sudden acceleration or deceleration, etc.), the system looks at the seconds before, during, and after such an “event” to determine whether it is a genuine event or a result of a change in position or orientation. The analyzing system becomes more accurate upon receipt of more driver's performance data as it creates more and better benchmarks for identifying changes in position or orientation of the mobile device.

The system could also use axis calibration to interpret data from the accelerometer accurately. The method provides for transforming three dimensional driving performance data as received from the accelerometer to the vehicle's coordinates system. Such transformation could be performed using the GPS receiver and additional sensors of the mobile device. The system defines the mobile device orientation according to three angles and three offsets (one for each dimension). The system could obtain data from the GPS receiver and the accelerometer, which could exclude noisy data samples (e.g., time segments of non-driving, bad GPS reception, etc.). Then, the system performs derivation on the data from the GPS receiver, as changes in speed and direction could be used to estimate front and side accelerations.

As to rotation data, an optimization process could be applied on rotation acceleration data to determine a minimal value between the rotated accelerations and the estimated (GPS based) acceleration. The rotation algorithm could be applied periodically to detect re-positioning of the mobile device and to improve accuracy.

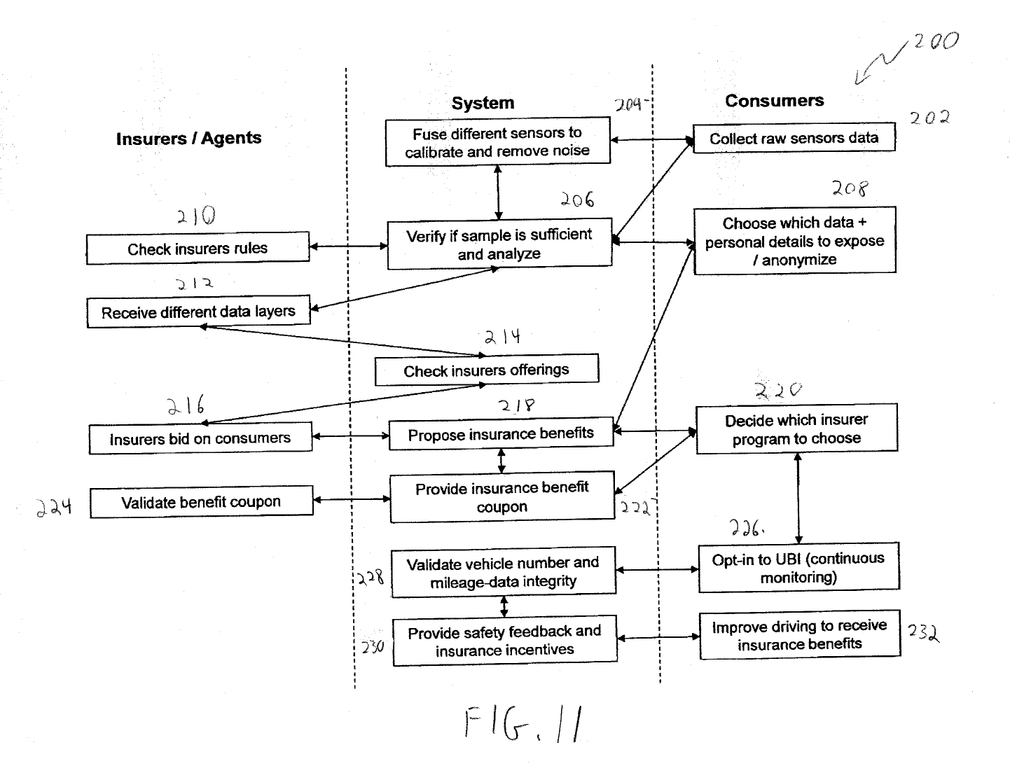

FIG. 11 is a flowchart showing overall processing steps 200 carried out by the system for handling driving performance data. In step 202, the system collects raw data from the sensors (e.g., GPS receiver, accelerometer, and other sensors). In step 204 the system fuses (aggregates data from) different sensors for calibration and removes noise from the raw data collected in step 202. In step 206, the system determines if the amount of raw data is sufficient for an insurer. Such determination could be a function of a predefined amount of data requested by the insurers, as shown in step 210. If there is not enough information, the process reverts back to step 202 and the system continues collecting raw data. If there is enough collected data, then as shown in step 208, the system asks the driver to identify the level of data exposure he or she wishes to provide to an insurer (e.g., gender, age, zip code, etc.). The driver could also determine the exposure level of the detected driver's performance data (e.g., driving performance data), such as time frame, remove location-related data, etc.

Once there is enough data and the level of exposure is obtained, in step 212, the system asks the insurer to identify the level of complexity of data to be provided (e.g., whether to provide raw data, normalized data, aggregated raw data, a score related to driving risk, data compared to risks, etc.). Next, in step 214, the system checks offers from various insurers. In some cases, as shown in step 216, several insurers could bid on a referral of the driver, personal data of the driver, or driver's performance data of the driver. In step 218, the system transmits the offers from the insurers to the driver. The offer or referral process could comprise issuance of a coupon as shown in step 224. The insurer validates the coupon, as shown in step 222.

In step 226, the consumer receives the offers obtained in step 218 and selects the insurance he or she prefers. The consumer could choose to keep being monitored on a usage based insurance (UBI) basis. In such a case, as shown in step 228, the system verifies that the data relates to the insured vehicle and validates that the mobile device was present in the vehicle during most of the trip taken by the vehicle. After receiving additional raw data over time (e.g., once a month), in step 230, the system could provide the driver with safety feedback and insurance incentives, as well as fuel consumption tips. In step 232, the driver is urged to improve driving and receive insurance benefits accordingly.

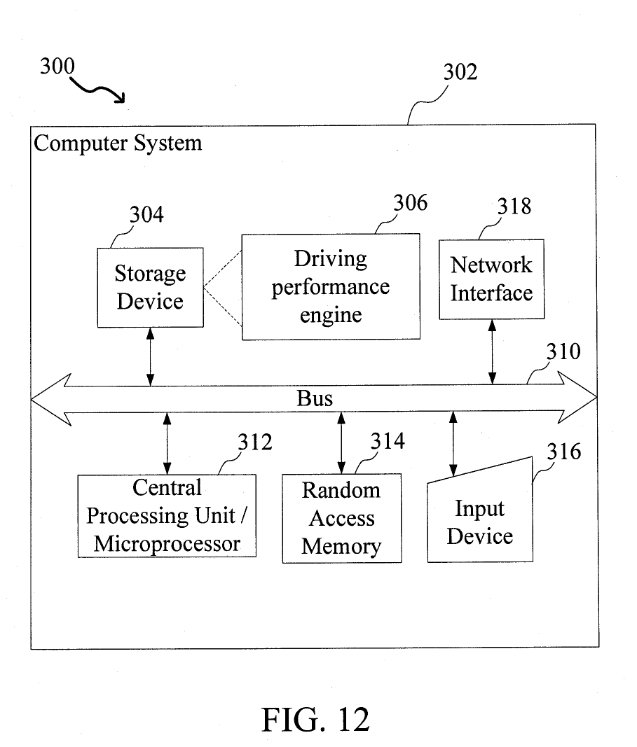

FIG. 12 is a diagram showing hardware and software components of the system 300 capable of performing the processes discussed above. The system 300 comprises a computer system 302 which could include a storage device 304, a network interface 318, a communications bus 310, a central processing unit (CPU) (microprocessor) 312, a random access memory (RAM) 314, and one or more input devices 316, such as a keyboard, mouse, etc. The computer system 302 could also include a display (e.g., liquid crystal display (LCD), cathode ray tube (CRT), etc.). The storage device 304 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 302 could be a networked computer system, a personal computer, a smart phone, etc.

The present invention could be embodied as a data matching software module or engine 306, which could be embodied as computer-readable program code stored on the storage device 304 and executed by the CPU 312 using any suitable, high or low level computing language, such as Java, C, C++, C#, .NET, etc. The network interface 318 could include an Ethernet network interface device, a wireless network interface device, or any other suitable device which permits the server 302 to communicate via the network. The CPU 312 could include any suitable single- or multiple-core microprocessor of any suitable architecture that is capable of implementing and running the driving performance program 306 (e.g., Intel processor). The random access memory 314 could include any suitable, high-speed, random access memory typical of most modern computers, such as dynamic RAM (DRAM), etc.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A system for detecting driving performance data, comprising:
one or more mobile devices in electronic communication with a network and one or more sensors for measuring at least one parameter associated with operation of a vehicle;
a driving performance engine in electronic communication with the mobile device, the driving performance engine verifying the vehicle or a driver of the vehicle, detecting vehicle dynamics by comparing sensor data obtained by the one or more mobile devices with a predefined set of rules, recording driving performance data, transmitting the driving performance data anonymously to an insurance provider computer system, and receiving insurance cost information from the insurance provider computer system based on the driving performance data.

2. The system of claim 1, wherein the one or more mobile devices is in electronic communication with an onboard system of the vehicle.

3. The system of claim 1, wherein the driving performance engine detects use of the one or more mobile devices while the vehicle is being driven.

4. The system of claim 1, wherein the driving performance engine identifies an accident and records accident information by comparing sensor data with the predefined set of rules.

5. The system of claim 1, wherein the driving performance engine verifies a vehicle by Bluetooth or WiFi connection.

6. The system of claim 1, wherein the driving performance engine automatically distinguishes between drivers of the vehicle by comparing driving styles based on driving performance data.

7. The system of claim 1, wherein the driving performance engine provides feedback to the driver or an owner of the vehicle based on the driving performance data.

8. The system of claim 1, wherein the one or more mobile devices includes a GPS receiver, an acceleration sensor, or a gyroscope and obtains GPS, acceleration, or dynamics information.

9. The system of claim 1, wherein the driving performance data includes media files.

10. The system of claim 1, wherein the driving performance engine optimizes the amount of driving performance data collected based on insurance benefits provided by the insurance provider computer system.

11. The system of claim 1, wherein the driving performance engine is monitoring a position or orientation or usage of the one or more mobile devices in the vehicle.

12. The system of claim 11, wherein the driving performance engine is detecting a change in the position or orientation of the one or more mobile devices and determining the new position or orientation of the one or more mobile devices based on data from different sensors of the one or more mobile devices.

13. A method for detecting driving performance data comprising:
electronically obtaining from one or more sensors at least one parameter associated with operation of a vehicle at one or more mobile devices, the one or more mobile devices in electronic communication with a network;
processing the information using a driving performance engine in electronic communication with the one or more mobile devices;
verifying, by the driving performance engine, the vehicle or a driver of the vehicle;
detecting, by the driving performance engine, vehicle dynamics by comparing sensor data obtained by the one or more mobile devices with a predefined set of rules;
recording driving performance data by the driving performance engine;
transmitting the driving performance data anonymously to an insurance provider computer system; and
receiving insurance cost information from the insurance provider computer system based on the driving performance data.

14. The method of claim 13, wherein the one or more mobile devices is in electronic communication with an onboard system of the vehicle.

15. The method of claim 13, further comprising detecting, by the driving performance engine, use of the one or more mobile devices while the vehicle is being driven.

16. The method of claim 13, further comprising identifying an accident and recording accident information by comparing sensor data with the predefined set of rules.

17. The method of claim 13, wherein the driving performance engine verifies a vehicle by Bluetooth or WiFi connection.

18. The method of claim 13, automatically distinguishing, by the driving performance engine, between drivers of the vehicle by comparing driving styles based on driving performance data.

19. The method of claim 13, further comprising providing, by the driving performance engine, feedback to the driver or an owner of the vehicle based on the driving performance data.

20. The method of claim 13, wherein the one or more mobile devices includes a GPS receiver, an acceleration sensor, or a gyroscope and obtains GPS, acceleration, or dynamics information.

21. The method of claim 13, wherein the driving performance data includes media files.

22. The method of claim 13, further comprising optimizing an amount of driving performance data collected based on insurance benefits provided by the insurance provider computer system.

23. The method of claim 13, further comprising monitoring, by the driving performance engine, a position or orientation or usage of the one or more mobile devices in the vehicle.

24. The method of claim 23, further comprising detecting, by the driving performance engine, a change in the position or orientation of the one or more mobile devices and determining, by the driving performance engine, the new position or orientation of the one or more mobile devices based on data from different sensors of the one or more mobile devices.

25. A computer-readable medium having computer-readable instructions stored thereon which, when executed by a computer system, cause the computer system to perform the steps of:
electronically obtaining from one or more sensors at least one parameter associated with operation of a vehicle at one or more mobile devices, the one or more mobile devices in electronic communication with a network;
processing the information using a driving performance engine in electronic communication with the one or more mobile devices;
verifying, by the driving performance engine, the vehicle or a driver of the vehicle;
detecting, by the driving performance engine, vehicle dynamics by comparing sensor data obtained by the one or more mobile devices with a predefined set of rules;
recording driving performance data by the driving performance engine;
transmitting the driving performance data anonymously to an insurance provider computer system; and
receiving insurance cost information from the insurance provider computer system based on the driving performance data.

26. The computer-readable medium of claim 25, wherein the one or more mobile devices is in electronic communication with an onboard system of the vehicle.

27. The computer-readable medium of claim 25, further comprising detecting, by the driving performance engine, use of the one or more mobile devices while the vehicle is being driven.

28. The computer-readable medium of claim 25, further comprising identifying an accident and recording accident information by comparing sensor data with the predefined set of rules.

29. The computer-readable medium of claim 25, wherein the driving performance engine verifies a vehicle by Bluetooth or WiFi connection.

30. The computer-readable medium of claim 25, automatically distinguishing, by the driving performance engine, between drivers of the vehicle by comparing driving styles based on driving performance data.

31. The computer-readable medium of claim 25, further comprising providing, by the driving performance engine, feedback to the driver or an owner of the vehicle based on the driving performance data.

32. The computer-readable medium of claim 25, wherein the one or more mobile devices includes a GPS receiver, an acceleration sensor, or a gyroscope and obtains GPS, acceleration, or dynamics information.

33. The computer-readable medium of claim 25, wherein the driving performance data includes media files.

34. The computer-readable medium of claim 25, further comprising optimizing an amount of driving performance data collected based on insurance benefits provided by the insurance provider computer system.

35. The method of claim 25, further comprising monitoring, by the driving performance engine, a position or orientation or usage of the one or more mobile devices in the vehicle.

36. The method of claim 35, further comprising detecting, by the driving performance engine, a change in the position or orientation of the one or more mobile devices and determining, by the driving performance engine, the new position or orientation of the one or more mobile devices based on data from different sensors of the one or more mobile devices.
